(19) United States
(12) Patent Application Publication
(10) Pub. No.: US 2005/0023802 A1
(43) Pub. Date: Feb. 3, 2005

(54) Adapter unit for a knee airbag

(76) Inventors: Mark L. Enders, Pleasant View, UT (US); Alan R. Larsen, Layton, UT (US); Bradley W. Smith, Ogden, UT (US)

Correspondence Address: Sally J. Brown;AUTOLIV ASP, INC., 3350 Airport Road, Ogden, UT, 84405, US

(21) Appl. No.: 10/631,140

(22) Filed: Jul. 31, 2003

(51) Int. Cl. B60R 21/22

(52) U.S. Cl. 280/728.2; 280/730.1

(57) ABSTRACT

An adapter unit for a rigid knee airbag is provided. The adapter unit enables a rigid knee airbag to be in communication with an inflator having a diffuser portion for disseminating inflation fluid into the airbag. The rigid knee airbag includes a front panel and a back panel. The adapter unit may include an impression formed in the back panel. The inflator may include a male fastener attached to the diffuser portion of the inflator. The inflator may be inserted into a large orifice in a first substantially planar end portion of the impression such that the male fastener extends through a small orifice in a second substantially planar end portion of the impression. A female fastener may then be used to attach the inflator to the second substantially planar end portion. Alternatively, the adapter unit may include a housing that is similar to the impression formed in the back panel described above. Alternatively still, the adapter unit may include a raised portion formed in the back panel, the raised portion including an orifice having a diameter that is slightly smaller than the diameter of the diffuser portion of a disk inflator.

### BACKGROUND OF THE INVENTION

1. Field of the Invention

The present invention relates to a knee airbag designed to protect the occupants of a vehicle during a collision. More specifically, the invention relates to an adapter unit for a knee airbag that may be securely attached to the diffuser portion of an airbag inflator.

2. Description of Related Art

Inflatable airbags enjoy widespread acceptance as passive passenger restraints for use in motor vehicles. In fact, vehicle manufacturers are now required to install airbags in most new vehicles manufactured for sale in the United States.

Airbags are often installed in the steering wheel and in the dashboard on the passenger side of a car. These airbags are typically covered by a trim cover panel that is made of plastic, and that is configured to be opened by the pressure created by the deploying airbag. These airbags are typically used for the primary deceleration of a vehicle occupant since, in a large fraction of collisions, the occupant is accelerated forward toward the windshield. Thus, such an airbag will be referred to herein as a “primary airbag.”

A primary airbag is typically in communication with an inflator, which is typically in communication with a sensor mechanism configured to sense an impact to the vehicle. Upon receipt of an electrical signal transmitted from the sensor mechanism, the inflator discharges, causing the primary airbag to inflate. In its inflated position, the primary airbag prevents the upper body portion of a vehicle occupant from being propelled forward toward the windshield. When this occurs, there is a tendency for the lower body portion of the occupant to be propelled forward and under the primary airbag. This tendency is referred to as “submarining,” and may be quite pronounced when the occupant is not properly restrained by a seat belt.

Knee airbags have been developed in order to prevent submarining. Knee airbags deploy during a collision event and engage an occupant's knees or lower legs, thus holding the occupant in place on the seat and preventing submarining.

Knee airbags typically include a back panel attached to a front panel. The back panel and the front panel are typically made from a material such as sheet metal. The front panel may be attached to a decorative trim panel. The trim panel allows some degree of deformation to minimize the impact to an occupant.

An adapter unit enables the knee airbag to be in communication with an inflator. There are, however, several disadvantages with known adapter units for knee airbags. For example, many knee airbag systems use an inflator located at a remote location. Such systems require the use of costly gas guides suitable for conducting hot inflation fluid from the inflator to the airbag.

Even where the inflator is directly attached to the airbag, problems exist with known adapter units. Because dissemination of inflation fluid into the airbag occurs through the diffuser portion of the inflator, it is desirable to securely fasten the diffuser portion to the airbag. However, known adapter units for knee airbags do not provide this capability. In addition, known adapter units require the use of relatively expensive inflator housing structures.

Accordingly, it would be an advancement in the art to provide an adapter unit for a knee airbag that may be securely attached to the diffuser portion of an inflator. It would be a further advancement in the art to provide an adapter unit for a knee airbag that may be manufactured at a lower cost than known adapter units. The present invention provides these advancements in a novel and useful way.

### SUMMARY OF THE INVENTION

The apparatus of the present invention has been developed in response to the present state of the art, and in particular, in response to the problems and needs in the art that have not yet been fully solved by currently available adapter units for knee airbags. Thus, it is an overall objective of the present invention to provide an adapter unit for a knee airbag that may be securely attached to the diffuser portion of an inflator.

To achieve the foregoing objective, and in accordance with the invention as embodied and broadly described herein, an adapter unit for a rigid knee airbag is provided. The knee airbag may be positioned in any number of locations within a vehicle. For example, a primary airbag may be contained within a steering wheel. The knee airbag may then be mounted beneath the primary airbag in a lower portion of an instrument panel within the vehicle. In an alternative embodiment, the airbag may be positioned underneath a front seat.

The airbag includes a back panel and a front panel. Both the front panel and the back panel may be made from a rigid material, such as sheet metal. The front panel may be attached to a decorative trim panel which serves as a bolster for contacting the lower body portion of the occupant during a collision involving the vehicle, and which also allows the airbag to be integrated into the interior of the vehicle. Both the front panel and the back panel may be any desired shape.

The front panel may be attached to the back panel in any number of ways. For example, the peripheral region of the front panel may be folded around the peripheral region of the back panel. A plurality of spot welds may then be used to attach the front panel to the back panel. Alternatively, the area of the front panel may be substantially equal to the area of the back panel, and the peripheral regions of the front panel and the back panel may be welded together in a continuous fashion.

The adapter unit enables the knee airbag to be in communication with an inflator. The inflator may be of any suitable type or construction for supplying inflation fluid for inflating the airbag. The inflator includes a diffuser portion for disseminating the inflation fluid into the airbag.

The adapter unit is in communication with the back panel. The adapter unit may be integral with the back panel. Alternatively, the adapter unit may be separate from the back panel.

In one embodiment, the adapter unit includes an impression formed in the back panel of the airbag. The impression may include a substantially circular portion, a first substantially planar end portion, and a second substantially planar end portion. A large orifice may be pierced in the first substantially planar end portion. The diameter of the large orifice may be slightly larger than the diameter of the inflator.

The adapter unit is configured to become securely attached to the diffuser portion. For example, the inflator may include a male fastener attached to the diffuser portion of the inflator. The male fastener may take the form of a connector stud. A small orifice may be pierced in the second substantially planar end portion of the impression. The diameter of the small orifice may be slightly larger than the diameter of the connector stud. The inflator may be inserted into the large orifice in the first substantially planar end portion such that the connector stud extends through the small orifice in the second substantially planar end portion. A female fastener, such as a nut, may then be used to attach the inflator to the second substantially planar end portion.

A plastic sealing wedge may be placed around the inflator to create a tight seal between the inflator and the first substantially planar end portion. This may prevent inflation fluid from escaping out of the large orifice during discharge of the inflator. Alternatively, the diameter of the large orifice may simply be closely matched to the diameter of the inflator.

As stated previously, the adapter unit may be separate from the back panel. In one embodiment, the adapter unit may include a housing. The housing may take the form of a substantially flat plate with an impression formed therein. The impression may be similar to the impression formed in the back panel described above. In particular, the impression may include a substantially circular portion, a first substantially planar end portion, and a second substantially planar end portion. A large orifice may be pierced in the first substantially planar end portion, the large orifice having a diameter that is slightly larger than the diameter of the inflator. The inflator may include a connector stud attached to the diffuser portion of the inflator. A small orifice may be pierced in the second substantially planar end portion, the small orifice having a diameter that is slightly larger than the diameter of the connector stud. The inflator may be inserted into the large orifice in the first substantially planar end portion such that the connector stud extends through the small orifice in the second substantially planar end portion. A nut may then be used to attach the inflator to the second substantially planar end portion.

In an alternate embodiment, the adapter unit includes a raised portion formed in the back panel of the airbag. The raised portion may include an orifice configured to receive a disk inflator. In particular, the diameter of the orifice may be slightly smaller than the diameter of the diffuser portion of the disk inflator. The diffuser portion of the disk inflator may then be pressed into the orifice. This causes part of the raised portion to bend downward in a vertical direction, creating a lip portion. The lip portion encompasses the orifice, and therefore the disk inflator, thereby preventing the disk inflator from becoming separated from the back panel during discharge of the inflator.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages of the invention are obtained will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a side cutaway view of an interior portion of a vehicle having a folded knee airbag installed;

FIG. 2 is an exploded perspective view of the folded knee airbag of FIG. 1;

FIG. 3 is a top perspective view of the folded knee airbag of FIGS. 1-2 in its compact position;

FIG. 4 is a cross-sectional view of the folded knee airbag of FIGS. 1-3 taken along line A-A of FIG. 3;

FIG. 5 is an exploded perspective view of a folded knee airbag having an alternate adapter unit; and

FIG. 6 is an exploded perspective view of a folded knee airbag having an alternate adapter unit.

### DETAILED DESCRIPTION OF THE PREFERRED EMBODIMENTS

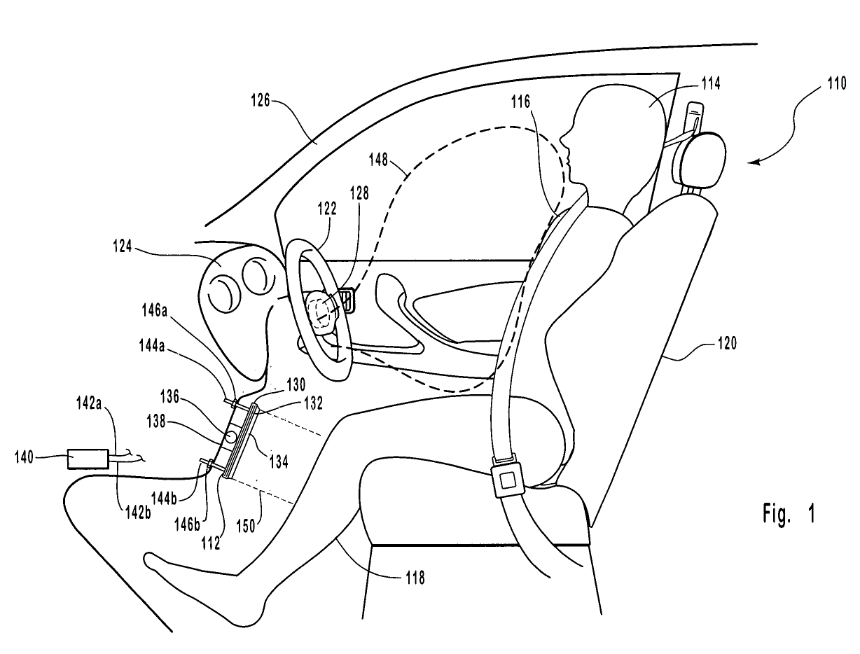

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the present invention, as represented in FIGS. 1 through 6, is not intended to limit the scope of the invention, as claimed, but is merely representative of presently preferred embodiments of the invention.

FIG. 1 is a side cutaway view of an interior portion of a vehicle 110 having a folded knee airbag 112 installed. A vehicle occupant 114 having an upper body portion 116 and a lower body portion 118 is shown seated in a front seat 120. The front seat 120 is located in front of a steering wheel 122, an instrument panel 124, and a windshield (not shown). A primary airbag 128 is contained within the steering wheel 122. The folded knee airbag 112 is mounted in a lower portion of the instrument panel 124 within the vehicle 110.

The folded rigid knee airbag 112 includes a back panel 130 and a front panel 132 which is attached to a decorative trim panel 134. The decorative trim panel 134 serves as a bolster for contacting the lower body portion 118 of the occupant 114 during a collision involving the vehicle 110. The trim panel 134 also allows the airbag 112 to be integrated into the interior of the vehicle 110.

The airbag 112 is in communication with an inflator 136 through an adapter unit 138, as will be explained in greater detail below. The vehicle 110 also includes a sensor mechanism 140, which is configured to sense an impact to the vehicle 110. A pair of lead wires 142a-b are attached to the sensor mechanism 140. The lead wires 142a-b provide electrical communication between the sensor mechanism 140 and the inflator 136. The airbag 112 is attached to the instrument panel 124 by a pair of threaded bolts 144a-b and held in place by a pair of nuts 146a-b.

Upon receipt of an electrical signal transmitted from the sensor mechanism 140, the primary airbag 128 and the rigid airbag 112 inflate into their respective inflated positions 148 and 150. In its inflated position 148, the primary airbag 128 prevents the upper body portion 116 of the occupant 114 from being propelled forward toward the windshield. When this occurs, there is a tendency for the lower body of the occupant 114 to be propelled forward and under the primary airbag 128. This tendency is referred to as submarining, and may be quite pronounced when the occupant 114 is not properly restrained by a seat belt. In its inflated position 150, the airbag 112 prevents submarining, i.e., prevents the lower body portion 118 of the vehicle occupant 114 from sliding forward.

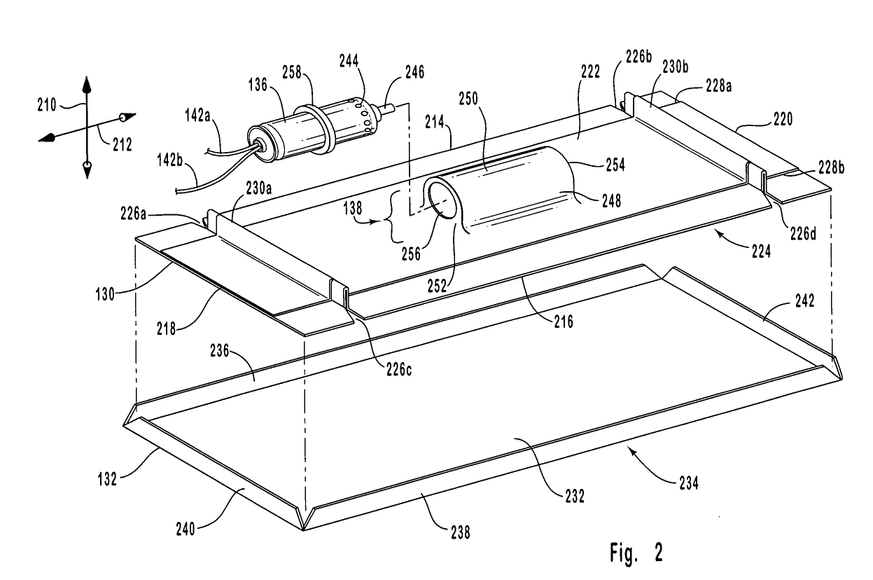

FIG. 2 is an exploded perspective view of the folded knee airbag 112. As stated previously, the airbag 112 includes a back panel 130, a front panel 132, an inflator 136, and an adapter unit 138 in communication with the back panel 130. The airbag 112 also has a vertical direction 210 and a horizontal direction 212.

The back panel 130 has an upper edge 214, a lower edge 216, a left side edge 218, and a right side edge 220. The back panel 130 also has a front side 222 and a back side 224 opposite the front side 222.

Four recesses 226a, 226b, 226c, and 226d are positioned around the perimeter of the back panel 130. A first recess 226a is positioned on the upper edge 214 toward the left side edge 218, a second recess 226b is positioned on the upper edge 214 toward the right side edge 220, a third recess 226c is positioned on the lower edge 216 toward the left side edge 218, and a fourth recess 226d is positioned on the lower edge 216 toward the right side edge 220.

First and second accordion folds 228a, 228b extend from the left side edge 218 to the right side edge 220 in a horizontal direction 212. A first vertical fold 230a protrudes out of the front side 222 in a vertical direction 210 and extends from the first recess 226a to the third recess 226c. Similarly, a second vertical fold 230b protrudes out of the front side 222 in a vertical direction 210 and extends from the second recess 226b to the fourth recess 226d.

The first vertical fold 230a intersects the first accordion fold 228a near the upper edge 214 and the left side edge 218. The first vertical fold 230a intersects the second accordion fold 228b near the lower edge 216 and the left side edge 218. The second vertical fold 230b intersects the first accordion fold 228a near the upper edge 214 and the right side edge 220. The second vertical fold 230b intersects the second accordion fold 228b near the lower edge 216 and the left side edge 218.

The accordion folds 228a, 228b and the vertical folds 230a, 230b allow the front panel 132 to remain substantially flat during inflation. This permits the airbag 112 to inflate evenly, thereby reducing the likelihood that the trim panel 134 will interact with the vehicle occupant 114 at an angle during an accident. In addition, the cross-sectional area of the airbag 112 in its inflated configuration is about the same as the cross-sectional area of the airbag 112 in its compact configuration. This allows the airbag 112 to be more easily integrated into the interior of the vehicle 110.

The front panel 132 has a front side 232 and a back side 234 opposite the front side 222. The front panel 132 has an upper peripheral region 236, a lower peripheral region 238, a left peripheral region 240, and a right peripheral region 242, all of which are bent at a 90° angle toward the front side 222. The area of the front panel 132 is greater than the area of the back panel 130 to allow the peripheral regions 236, 238, 240, and 242 to be folded around the edges 214, 216, 218, and 220 of the back panel 130.

Both the back panel 130 and the front panel 132 are preferably made from a rigid material. For example, the back panel 130 and the front panel 132 may be made from sheet metal and/or plastics.

In an alternative embodiment, the accordion folds 228a-b and the vertical folds 230a-b may be omitted. In such case, the area of the front panel 132 may be made about equal to the area of the back panel 130. The peripheral regions of the front panel 132 may then be attached to the peripheral regions of the front panel 132 by any number of suitable techniques, such as welding.

The inflator 136 may be of any suitable type or construction for supplying a medium for inflating the folded rigid knee airbag 112. For example, the inflator 136 may be a pyrotechnic inflator that uses the combustion of gas-generating material to generate an inflation fluid that inflates the folded rigid knee airbag 112. The inflator 136 includes a diffuser portion 244 for disseminating the inflation fluid, and lead wires 142a-b which enable the inflator 136 to be in electrical communication with the sensor mechanism 140. The inflator 136 also includes a male fastener 246 attached to the diffuser portion 244 of the inflator 136. The male fastener 246 may take the form of a connector stud 246.

As stated previously, the adapter unit 138 is in communication with the back panel 130. In the embodiment shown in FIG. 2, the adapter unit 138 is integral with the back panel 130. In particular, the adapter unit 138 consists of an impression 248 formed in the back panel 130 of the airbag 112. The impression 248 may be created by stamping a portion of the back panel 130 with, for example, a progression die (not shown). The impression 248 has a substantially circular portion 250, a first substantially planar end portion 252, and a second substantially planar end portion 254. Of course, the impression 248 may be any desired shape. For example, the substantially circular portion 250 may instead be substantially rectangular. Whatever shape it takes, the impression 248 is made sufficiently large to accommodate an inflator, such as the inflator 136 described previously. A large orifice 256 is pierced in the first substantially planar end portion 252. The large orifice 256 has a diameter which is slightly larger than the diameter of the inflator 136.

When the inflator 136 discharges, it is desirable to prevent inflation fluid from escaping out of the large orifice 256. This may be accomplished in a variety of ways. For example, in the embodiment shown in FIG. 2, a plastic sealing wedge 258 is placed around the inflator 136. When the inflator 136 is inserted into the large orifice 256, the sealing wedge 258 creates a tight seal between the inflator 136 and the first substantially planar end portion 252.

When the inflator 136 discharges, it is also desirable for the inflator 136 to be secured to the back panel 130 so that the force of the discharge does not cause the inflator 136 to be propelled out of the large orifice 256 away from the adapter unit 138. As mentioned previously, the inflator 136 includes a connector stud 246 attached to the diffuser portion 244 of the inflator 136. A small orifice (not shown in FIG. 2) is pierced in the second substantially planar end portion 254 of the impression 248. The small orifice has a diameter which is slightly larger than the connector stud 246. The inflator 136 may be inserted into the large orifice 256 such that the connector stud 246 extends through the small orifice. A nut (not shown in FIG. 2) may then be used to attach the inflator 136 to the second substantially planar end portion 254 of the back panel 130.

In an alternative embodiment, the large orifice 256 is made to be slightly smaller than or equal to the diameter of the inflator 136. The adapter unit 138 is then securely attached to the inflator 136 through a press fit.

The inflator gas is discharged through the adapter and back panel 224. The gas is then trapped between panels 224 and 234. As pressure increases, the folds of panel 224 unfold, causing an expansion of space between panels 224 and 234.

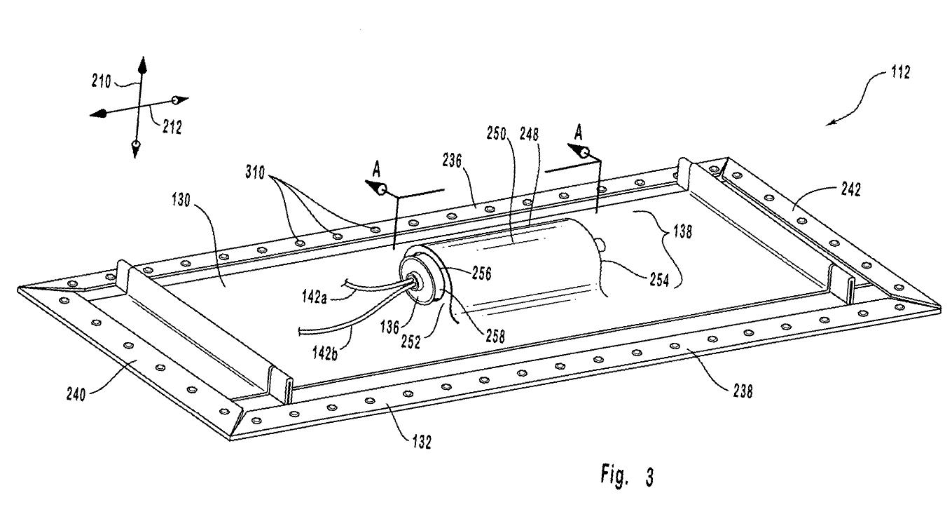

FIG. 3 is a top perspective view of the folded knee airbag 112 in its compact position. The upper peripheral region 236 of the front panel 132 is folded around the upper edge 214 of the back panel 130, the lower peripheral region 238 of the front panel 132 is folded around the lower edge 216 of the back panel 130, the left peripheral region 240 of the front panel 132 is folded around the left side edge 218 of the back panel 130, and the right peripheral region 242 of the front panel 132 is folded around the right side edge 220 of the back panel 130. A plurality of spot welds 310 are disposed around each of the peripheral regions 236, 238, 240, and 242 to attach the front panel 132 to the back panel 130.

The inflator 136 is inserted into the large orifice 256 in the impression 248 so that the connector stud 246 extends through the small orifice (not shown in FIG. 3) in the impression 248. A nut (not shown in FIG. 3) is fastened to the connector stud 246 to secure the inflator 136 to the adapter unit 138. The plastic sealing wedge 258 creates a tight seal between the inflator 136 and the back panel 130.

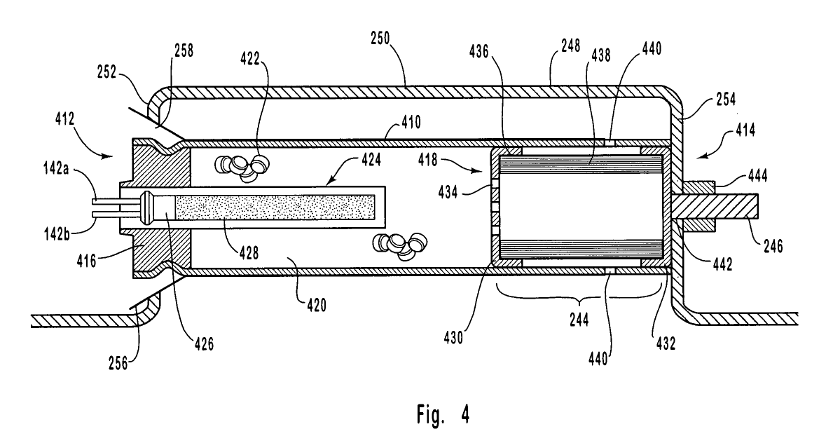

FIG. 4 is a cross-sectional view of the folded metal airbag 112 shown in FIG. 3 taken along line A-A in FIG. 3. The inflator 136 includes a tubular housing 410 having a first end portion 412 and a second end portion 414. A first cover 416 seals the first end portion 412, and a filter insert 418 seals the second end portion 414. A combustion chamber 420 and the diffuser portion 244 are disposed between the first end portion 412 and the second end portion 414.

The combustion chamber 420 is packed with propellant 422. An elongated ignition unit 424 extends into the combustion chamber 420. The ignition unit 424 includes an igniter 426 and a booster charge 428. The lead wires 142a-b are attached to the igniter 426 and extend out of the ignition unit 424. When the vehicle 110 is involved in a collision, the igniter 426 is activated via the sensor mechanism 140 over the lead wires 142a-b. The igniter 426 and the booster charge 428 together ignite the propellant 422, thereby generating an inflation fluid that may be used to inflate the folded knee airbag 112.

The diffuser portion 244 includes a filter insert 418. The filter insert 418 includes an outer housing having a first end wall 430 and a second end wall 432 opposite the first end wall 430. The first end wall 430 defines the boundary between the diffuser portion 244 and the combustion chamber 420. Ports 434 in the first end wall 430 permit passage of the inflation fluid from the combustion chamber 420 into the diffuser portion 244. A supporting ring 436 connects the end walls 430 and 432 to each other by a press fit. The supporting ring 436 is gas permeable and is made of a perforated plate or a wire mesh. A filter 438 contacts the supporting ring. The filter 438 prevents dirt and other foreign particles from passing into the airbag 112. A plurality of exit ports 440 allow the inflation fluid to pass from the diffuser portion 244 into the airbag 112.

Of course, the configuration of the inflator 136 illustrated in FIG. 4 is exemplary only. Numerous other configurations for the inflator 136 will be readily apparent to one skilled in the art in light of the teachings contained herein.

As stated previously, the impression 248 in the back panel 130 has a substantially circular portion 250, a first substantially planar end portion 252, and a second substantially planar end portion 254. A large orifice 256 is pierced in the first substantially planar end portion 252. The plastic sealing wedge 258 creates a tight seal between the inflator 136 and the first substantially planar end portion 252 of the impression 248 in the back panel 130.

The inflator 136 includes a connector stud 246 attached to the diffuser portion 244 of the inflator 136. A small orifice 442 is pierced in the second substantially planar end portion 254 of the impression 248. The inflator 136 is inserted into the large orifice 256 such that the connector stud 246 extends through the small orifice 442. A nut 444 is screwed onto the connector stud 246 to attach the inflator 136 to the second substantially planar end portion 254.

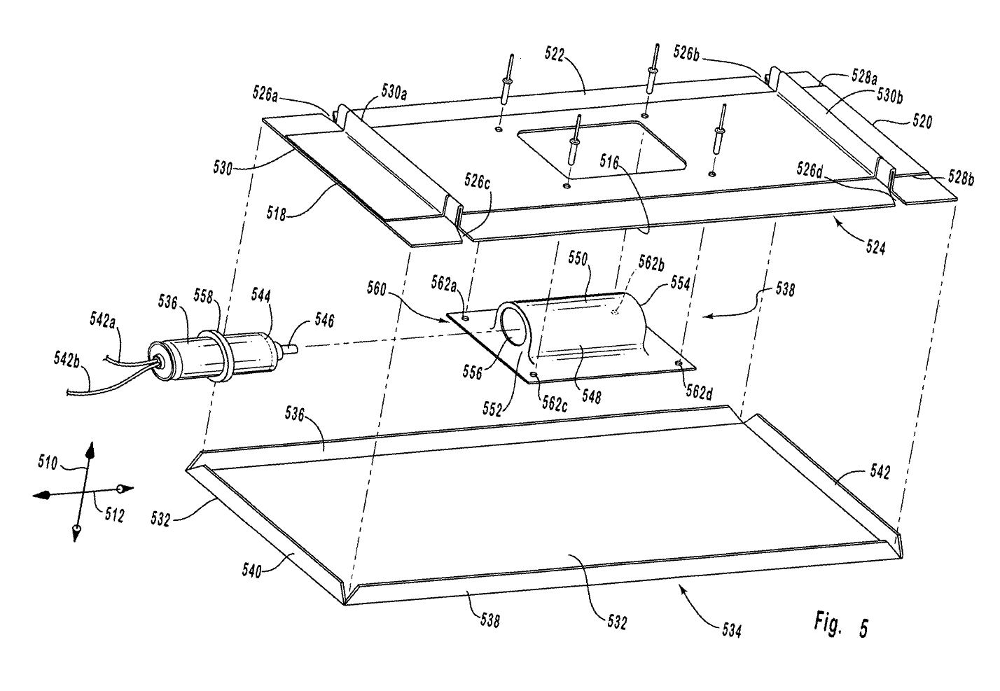

FIG. 5 is an exploded perspective view of a knee airbag having an alternate adapter unit 538. Many of the elements shown in FIG. 5 correspond to elements in FIGS. 1-2 and are labeled with similar reference numbers. For example, the adapter unit 138 in FIGS. 1-2 is labeled 538 in FIG. 5.

Once again, the adapter unit 538 is in communication with the back panel 524. However, in the embodiment shown in FIG. 5, the adapter unit 538 is distinct from the back panel 524. In particular, the adapter unit 538 includes a housing 560. The housing 560 is a substantially flat plate with an impression 548 formed therein. The impression 548 is similar to the impression 248 shown in FIG. 2. In particular, the impression 548 has a substantially circular portion 550, a first substantially planar end portion 552, and a second substantially planar end portion 554. As with the impression 248 shown in FIG. 2, the impression 548 may be any desired shape.

The impression 548 is made sufficiently large to accommodate an inflator 536. The inflator 536 shown in FIG. 5 is similar to the inflator 136 shown in FIGS. 1-2. A large orifice 556 is pierced in the first substantially planar end portion 552. The large orifice 556 has a diameter which is slightly larger than the diameter of the inflator 536. A plastic sealing wedge 558 is placed around the inflator 536. When the inflator 536 is inserted into the large orifice 556, the sealing wedge 558 creates a tight seal between the inflator 536 and the first substantially planar portion 552 of the housing 560. Alternatively, the diameter of the large orifice 556 may simply be closely matched to the diameter of the inflator 536.

As before, the inflator 536 includes a connector stud 546 attached to the diffuser portion 544 of the inflator 536. A small orifice (not shown) is pierced in the second substantially planar end portion 554 of the impression 548. The small orifice has a diameter which is slightly larger than the connector stud 546. The inflator 536 may be inserted into the large orifice 556 such that the connector stud 546 extends through the small orifice. A nut (not shown) may then be used to attach the inflator 536 to the second substantially planar end portion 554 of the housing 560.

The housing 560 includes four small orifices 562a-d disposed around its peripheral region. Each of the small orifices 562a-d is configured to receive a male fastener, such as a connector stud or rivet. The back panel 529 also includes four small orifices 564a-d which match the small orifices 56 in the housing 410. The housing may then be attached to the back panel 529 with a plurality of male and female fasteners in a known manner. Alternatively, the housing may be attached to the back panel with a plurality of spot welds.

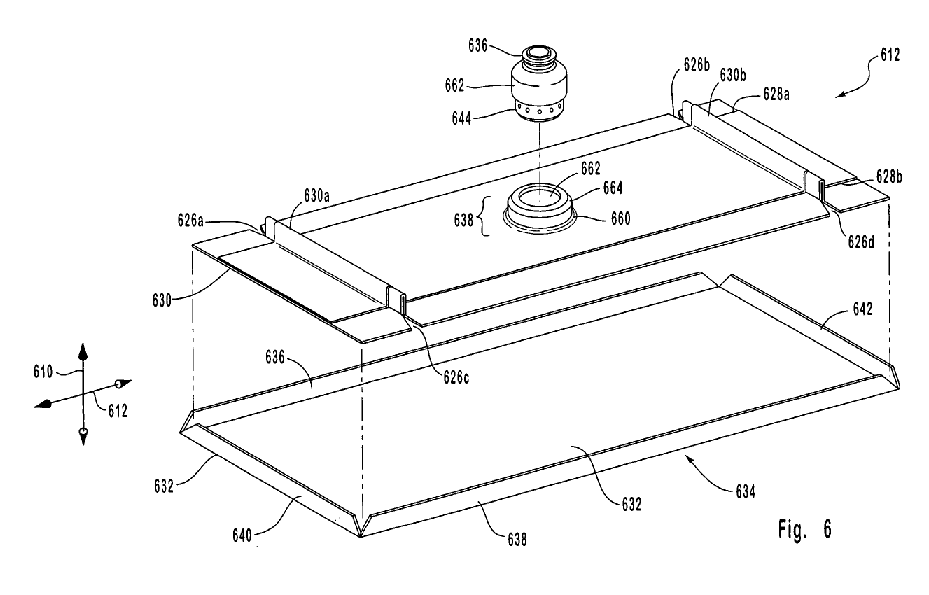

FIG. 6 is a top perspective view of a detached folded rigid knee airbag 612 having an alternate adapter unit 638. Many of the elements shown in FIG. 6 correspond to elements in FIG. 5 and are labeled with similar reference numbers. For example, the adapter unit 538 in FIG. 5 is labeled 638 in FIG. 6.

Once again, the adapter unit 638 is in communication with the back panel 629. As with the adapter unit 638 shown in FIGS. 2-4, the adapter unit 638 shown in FIG. 6 is integral with the back panel 629. In particular, the adapter unit 638 includes a raised portion 660. The raised portion 660 includes an orifice 662. The orifice 662 is configured to receive a disk inflator 636. The disk inflator 636 includes a combustion chamber 662 and a diffuser portion 644. The diameter of the orifice 662 is slightly smaller than the diameter of the diffuser portion 644.

Pressing the diffuser portion 644 of the disk inflator 636 into the orifice 662 causes a portion of the raised portion 660 to bend in a downward in a vertical direction 610. This creates a lip portion 664 encompassing the orifice 660 which prevents the disk inflator 636 from becoming separated from the back panel 629 during discharge of the inflator 636.

From the above discussion, it will be appreciated that many of the problems associated with known energy absorbers are addressed by the teachings of the present invention. The present invention provides an adapter unit for a knee airbag that may be securely attached to the diffuser portion of an inflator. In addition, the adapter unit presented herein may be manufactured at a lower cost than known adapter units.

The present invention may be embodied in other specific forms without departing from its essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An airbag for preventing the lower body portion of a vehicle occupant from being propelled during a collision, comprising:
a front panel made from a rigid material;
a back panel made from a rigid material and attached to the front panel; and
an adapter unit in communication with the back panel and securely attachable to a diffuser portion of an inflator.

2. The airbag of claim 1, wherein the adapter unit is integral with the back panel.

3. The airbag of claim 2, wherein the adapter unit further comprises an impression formed in the back panel, the impression comprising a first end portion configured to receive the inflator.

4. The airbag of claim 3, wherein the first end portion comprises an orifice having a first diameter, the first diameter being larger than the diameter of the inflator.

5. The airbag of claim 4, further comprising a sealing wedge disposed between the inflator and the first end portion.

6. The airbag of claim 3, wherein the first end portion comprises an orifice having a first diameter that is smaller than or equal to the diameter of the inflator, and wherein the adapter unit is securely attached to the diffuser portion of the inflator through a press fit.

7. The airbag of claim 3, further comprising a fastener attached to the diffuser portion of the inflator, and wherein the impression further comprises a second end portion configured to receive the fastener.

8. The airbag of claim 2, wherein the adapter unit comprises an orifice formed in the back panel.

9. The airbag of claim 8, wherein the back panel further comprises a lip portion encompassing the orifice, the lip portion being configured to prevent the diffuser portion of the inflator from becoming separated from the adapter unit during discharge of the inflator.

10. The airbag of claim 1, wherein the adapter unit is distinct from the back panel.

11. The airbag of claim 10, wherein the adapter unit comprises a housing having an impression formed therein, the impression having a first end portion configured to receive the inflator.

12. The airbag of claim 11, wherein the first end portion comprises an orifice having a first diameter, the first diameter being larger than the diameter of the inflator.

13. The airbag of claim 12, further comprising a sealing wedge disposed between the inflator and the first end portion.

14. The airbag of claim 11, wherein the first end portion comprises an orifice having a first diameter, the first diameter being substantially equal to the diameter of the inflator.

15. The airbag of claim 11, further comprising a fastener attached to the diffuser portion of the inflator, and wherein the impression further comprises a second end portion configured to receive the fastener.

16. The airbag of claim 1, wherein the rigid material comprises sheet metal.

17. The airbag of claim 1, wherein the rigid material comprises a plastic material.

18. An airbag system for preventing a vehicle occupant from being propelled during a collision, comprising:
a front panel made from a rigid material;
a back panel made from a rigid material and attached to the front panel;
an adapter unit in communication with the back panel; and
an inflator having a diffuser portion, the diffuser portion being attached to the adapter unit.

19. The airbag system of claim 18, wherein the adapter unit is integral with the back panel.

20. The airbag system of claim 19, wherein the adapter unit further comprises an impression formed in the back panel, the impression comprising a first end portion configured to receive the inflator.

21. The airbag system of claim 20, wherein the first end portion comprises an orifice having a first diameter, the first diameter being larger than the diameter of the inflator.

22. The airbag system of claim 21, further comprising a sealing wedge disposed between the inflator and the first end portion.

23. The airbag system of claim 20, wherein the first end portion comprises an orifice having a first diameter that is smaller than or equal to the diameter of the inflator, and wherein the adapter unit is securely attached to the diffuser portion of the inflator through a press fit.

24. The airbag system of claim 20, further comprising a fastener attached to the diffuser portion of the inflator, and wherein the impression further comprises a second end portion configured to receive the fastener.

25. The airbag system of claim 19, wherein the adapter unit comprises an orifice formed in the back panel.

26. The airbag system of claim 25, wherein the back panel further comprises a lip portion encompassing the orifice, the lip portion being configured to prevent the diffuser portion of the inflator from becoming separated from the adapter unit during discharge of the inflator.

27. The airbag system of claim 18, wherein the adapter unit is distinct from the back panel.

28. The airbag system of claim 27, wherein the adapter unit comprises a housing having an impression formed therein, the impression having a first end portion configured to receive the inflator.

29. The airbag system of claim 28, wherein the first end portion comprises an orifice having a first diameter, the first diameter being larger than the diameter of the inflator.

30. The airbag system of claim 29, further comprising a sealing wedge disposed between the inflator and the first end portion.

31. The airbag system of claim 28, wherein the first end portion comprises an orifice having a first diameter, the first diameter being substantially equal to the diameter of the inflator.

32. The airbag system of claim 28, further comprising a fastener attached to the diffuser portion of the inflator, and wherein the impression further comprises a second end portion configured to receive the fastener.

33. The airbag system of claim 18, wherein the rigid material comprises sheet metal.

34. The airbag system of claim 18, wherein the rigid material comprises a plastic material.

35. An airbag system for preventing a vehicle occupant from being propelled during a collision, comprising:
a front panel made from a rigid material, the front panel having a first side and a second side;
a decorative trim panel attached to the first side of the front panel;
a back panel made from a rigid material and attached to the second side of the front panel;
an adapter unit in communication with the back panel; and
an inflator having a diffuser portion, the diffuser portion being attached to the adapter unit.

36. The airbag system of claim 35, wherein the adapter unit is integral with the back panel.

37. The airbag system of claim 36, wherein the adapter unit further comprises an impression formed in the back panel, the impression comprising a first end portion configured to receive the inflator.

38. The airbag system of claim 37, wherein the first end portion comprises an orifice having a first diameter, the first diameter being larger than the diameter of the inflator.

39. The airbag system of claim 38, further comprising a sealing wedge disposed between the inflator and the first end portion.

40. The airbag system of claim 37, wherein the first end portion comprises an orifice having a first diameter that is smaller than or equal to the diameter of the inflator, and wherein the adapter unit is securely attached to the diffuser portion of the inflator through a press fit.

41. The airbag system of claim 37, further comprising a fastener attached to the diffuser portion of the inflator, and wherein the impression further comprises a second end portion configured to receive the fastener.

42. The airbag system of claim 36, wherein the adapter unit comprises an orifice formed in the back panel.

43. The airbag system of claim 42, wherein the back panel further comprises a lip portion encompassing the orifice, the lip portion being configured to prevent the diffuser portion of the inflator from becoming separated from the adapter unit during discharge of the inflator.

44. The airbag system of claim 35, wherein the adapter unit is distinct from the back panel.

45. The airbag system of claim 44, wherein the adapter unit comprises a housing having an impression formed therein, the impression having a first end portion configured to receive the inflator.

46. The airbag system of claim 45, wherein the first end portion comprises an orifice having a first diameter, the first diameter being larger than the diameter of the inflator.

47. The airbag system of claim 46, further comprising a sealing wedge disposed between the inflator and the first end portion.

48. The airbag system of claim 45, wherein the first end portion comprises an orifice having a first diameter, the first diameter being substantially equal to the diameter of the inflator.

49. The airbag system of claim 45, further comprising a fastener attached to the diffuser portion of the inflator, and wherein the impression further comprises a second end portion configured to receive the fastener.

50. The airbag system of claim 35, wherein the rigid material comprises sheet metal.

51. The airbag system of claim 35, wherein the rigid material comprises a plastic material.
